(19) United States
(12) Patent Application Publication
(10) Pub. No.: US 2005/0092138 A1
(43) Pub. Date: May 5, 2005

(54) Polygonal member engaging device

(76) Inventor: Chih-Ching Hsien, Taichung (TW)

Correspondence Address: Mr. Phillip Liu, 6980, Whiteoak Dr., Richmond, BC, V7E 4Z9, CA

(21) Appl. No.: 10/695,987

(22) Filed: Oct. 30, 2003

(51) Int. Cl. B25B 13/00

(52) U.S. Cl. 81/186

(57) ABSTRACT

A polygonal member engaging device includes a plurality of ridges and grooves defined in an inner periphery of a passage of the engaging device. The ridges and the grooves are alternatively arranged from each other in the inner periphery of the passage of the device. Each ridge has an enlarged portion extending radially outward therefrom. A ratio for a width between the two enlarged portions of two adjacent ridges and a width of a bottom of each groove being 1:1.2.

### FIELD OF THE INVENTION

The present invention relates to a polygonal member engaging device which includes twelve ridges and grooves alternatively defined in an inner periphery of a socket so as to more closely match an outer periphery of a polygonal member such as a nut.

### BACKGROUND OF THE INVENTION

A conventional socket 100 is shown in FIG. 10 and generally includes twelve ridges 101 and grooves 102 defined in an inner periphery of a passage defined through the socket 100. The ridges 101 and the grooves 102 are arranged in alternative arrangement with each other. It is expected that a hexagonal shaped nut 103 is received in the passage and each peak portion 1030 of the nut 103 is received in one of the grooves 102 and each side 1031 connected between the adjacent peak portions 1030 is in contact with one of the ridges 101. Nevertheless, it is noted that the width “W1” of the opening between the adjacent ridges 101 is larger than the width “W2” of the bottom of the groove 102, so that the socket has to be rotated an angle to match with the nut 103 before outputting a torque to the nut 103. In some working sites which includes a narrow space, it is not allowed the socket to rotate the angle without rotating the nut 103. Besides, there is a tolerance when making the passage to easily receive the nut 103 in the passage, and this tolerance results in a less number of the sides of the nut 103 being in contact with the ridges 101. Furthermore, the ridges 101 are in contact with the sides 1031 of the nut 103 at a far point away from the peak portion 1030 and this makes the peak portions 1030 to be easily rounded by the socket 100.

The present invention intends to provide a polygonal member engaging device that closely matches the nut and the ratio for the width “W” of the opening between the adjacent ridges and the width “W” of the bottom of the groove is 1:1.2.

### SUMMARY OF THE INVENTION

The present invention relates to a polygonal member engaging device which can be a socket or an engaging ring in a ratchet wrench. The engaging device includes a plurality of ridges and grooves defined in an inner periphery of a passage of the engaging device. The ridges and the grooves are alternatively arranged from each other in the inner periphery of the passage of the device. Each ridge has an enlarged portion extending radially outward therefrom. A ratio for a width between the two enlarged portions of two adjacent ridges and a width of a bottom of each groove being 1:1.2.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a ratchet wrench with the polygonal member engaging device of the present invention used as the engaging ring of the wrench;

FIG. 2 is a perspective view to show the ratchet wrench as shown in FIG. 1;

FIG. 3 is a cross sectional view to show the ratchet wrench as shown in FIG. 1;

FIG. 4 shows a nut is matched by the engaging ring as shown in FIG. 1;

FIG. 5 discloses the relationship of the width between two adjacent ridges and the width of the bottom of the groove of the engaging ring as shown in FIG. 1;

FIG. 6 shows a first embodiment of a socket of the present invention;

FIG. 7 shows the socket as shown in FIG. 6 is driven by the ratchet wrench as disclosed in FIG. 1;

FIG. 8 shows a second embodiment of a socket of the present invention;

FIG. 9 shows a third embodiment of a socket of the present invention, and

FIG. 10 shows a conventional socket and a nut engaged by the conventional socket.

### DETAILED DESCRIPTION OF THE PREFERRED EMBODIMENT

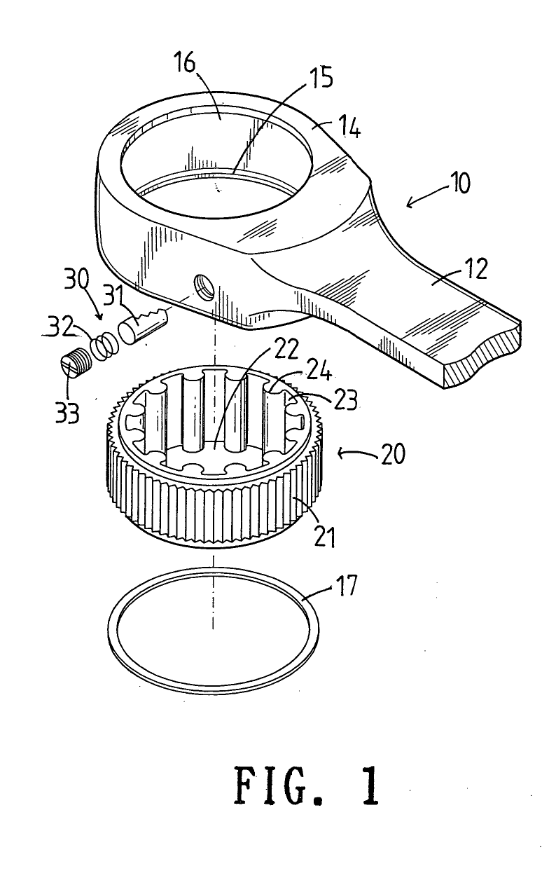

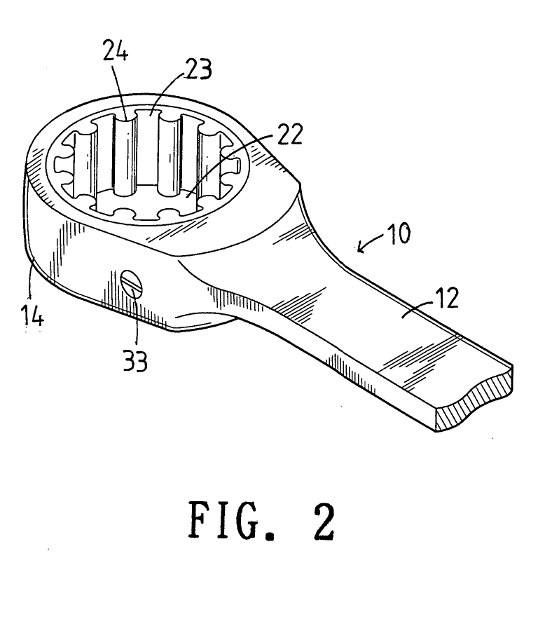

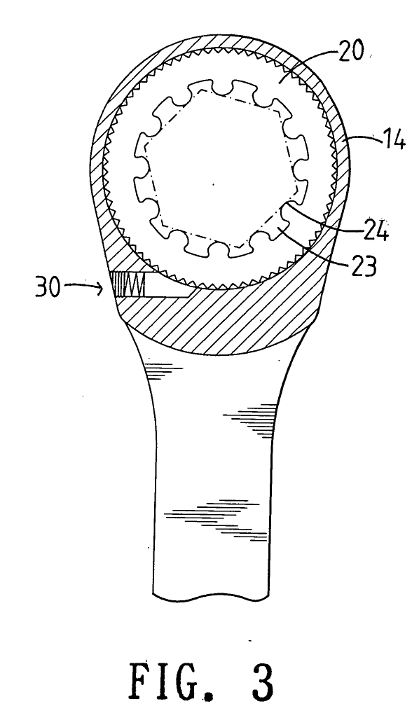

Referring to FIGS. 1 to 5, the polygonal member engaging device is used as an engaging ring 20 for a ratchet wrench 10 which comprises a head 14 and a handle 12 is connected to the head 14. The head 14 has a hole 16 defined therethrough and the engaging ring 20 is rotatably and retained in the hole 16 by connecting a ring 17 into the groove 15 in the inner periphery of the hole 16. A side passage is defined from a side of the head 14 and in communication with the hole 16 so as to receive a ratchet mechanism 30 therein which includes a pawl 31 and a spring 32 which is biased between an end of the pawl 31 and an end cap 33 to seal the side passage.

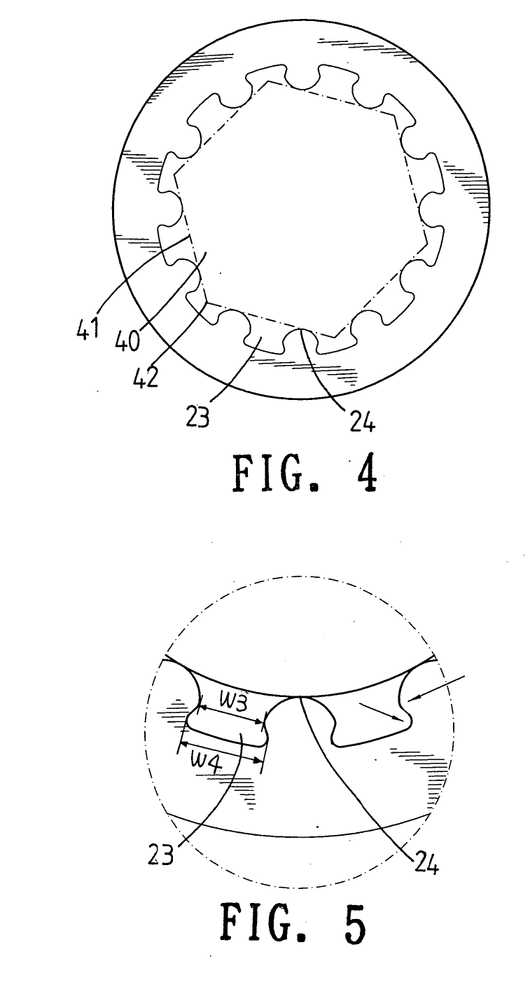

The engaging ring 20 has a toothed outer periphery 21 so as to be engaged with the teeth in the pawl 31, and a plurality of ridges 24 and grooves 23 are defined in an inner periphery of a passage 22 of the engaging ring 20. The ridges 24 and the grooves 23 are alternatively arranged from each other in the inner periphery of the passage of the engaging ring 20, and each ridge 24 has an enlarged portion 241 extending radially outward therefrom. A ratio for a width “W3” between the two enlarged portions 241 of two adjacent ridges 24 and a width “W4” of a bottom of each groove 23 being 1:1.2. A polygonal member such as a nut 40 is engaged with the passage of the engaging ring 20 and each peak portion 42 of the nut 40 is engaged with the groove 23 corresponding thereto and the sides 41 of the nut 40 are in contact with the ridges 24 as shown in FIG. 4. By the engaging ring 20, the nut 40 is securely clamped by the ridges 24 and the grooves 23 and every side 41 of the nut 40 is in contact with four ridges 24 so that the nut 40 is rotated from the beginning of the rotation of the engaging ring 20.

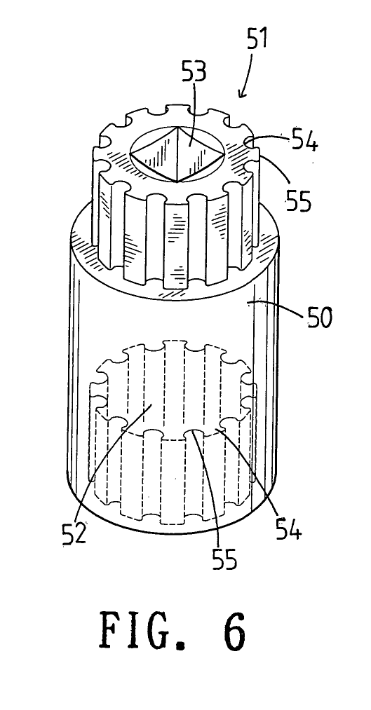

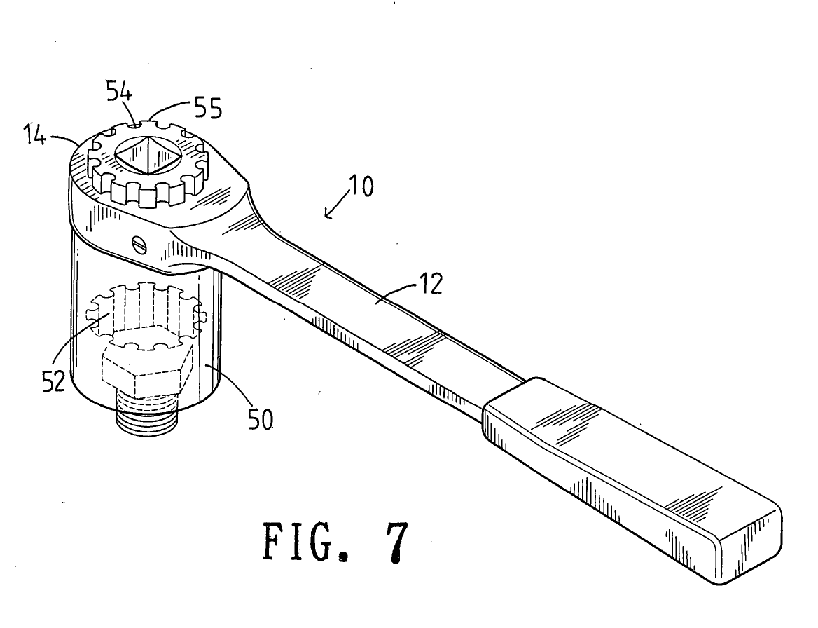

FIGS. 6 and 7 show a first embodiment of a socket of the present invention wherein the socket includes a tubular body 50 and an engaging recess 52 is defined in a first end of the tubular body 50. An engaging part 51 extends from a second end of the tubular body 50 and has a plurality of ridges 55 and grooves 54 defined in an outer periphery thereof. The ridges 55 and the grooves 54 are alternatively arranged from each other in the outer periphery of the engaging part 51. Each ridge 55 has an enlarged portion extending radially outward therefrom. A ratio for a width between the two enlarged portions of two adjacent ridges 55 and a width of a bottom of each groove 54 being 1:1.2. The engaging part 51 is engaged with the engaging ring 20 disclosed in the ratchet wrench 10 disclosed in FIG. 1 and the socket 50 can be rotated by operation the ratchet wrench 10. A bolt head is engaged with the engaging recess 52 and rotated by operation of the ratchet wrench 10.

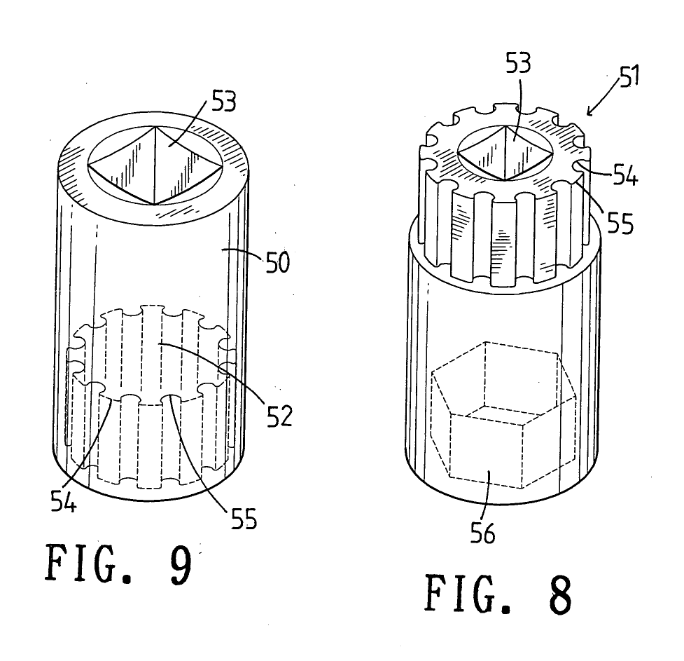

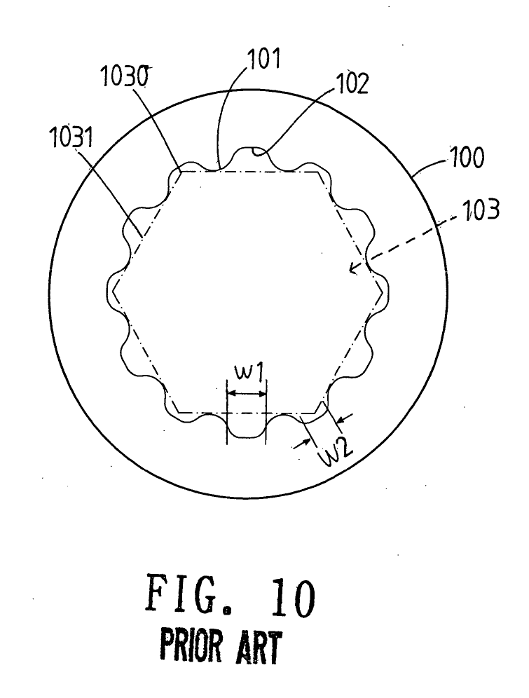

FIG. 8 shows a second embodiment of the socket of the present invention and the socket has the same structure as the first embodiment of the socket disclosed in FIG. 7, except that the engaging recess 56 is a hexagonal recess.

FIG. 9 shows a third embodiment of the socket 50 of the present invention and the socket which comprises a tubular body 50 having a rectangular connection recess 53 defined in a first end of the tubular body 50 so as to be connected to a wrench which is not shown and an engaging recess 52 is defined in a second end of the tubular body 50. The engaging recess 52 has a plurality of ridges 55 and grooves 54 defined in an inner periphery thereof. The ridges 55 and the grooves 54 are alternatively arranged from each other in the inner periphery of the engaging recess 52. Each ridge 55 has an enlarged portion extending radially outward therefrom. A ratio for a width between the two enlarged portions of two adjacent ridges 55 and a width of a bottom of each groove 54 is 1:1.2.

While we have shown and described the embodiment in accordance with the present invention, it should be clear to those skilled in the art that further embodiments may be made without departing from the scope of the present invention.

1. A wrench comprising:
a head and a handle connected to the head, the head having a hole defined therethrough and an engaging ring rotatably and retained in the hole, the engaging ring having a plurality of ridges and grooves defined in an inner periphery of a passage of the engaging ring, the ridges and the grooves being alternatively arranged from each other in the inner periphery of the passage of the engaging ring, each ridge having an enlarged portion extending radially outward therefrom, a ratio for a width “W3” between the two enlarged portions of two adjacent ridges and a width “W4” of a bottom of each groove being 1:1.2.

2. A socket comprising:
a tubular body and an engaging recess defined in a first end of the tubular body, an engaging part extending from a second end of the tubular body and having a plurality of ridges and grooves defined in an outer periphery thereof, the ridges and the grooves being alternatively arranged from each other in the outer periphery of the engaging part, each ridge having an enlarged portion extending radially outward therefrom, a ratio for a width between the two enlarged portions of two adjacent ridges and a width of a bottom of each groove being 1:1.2.

3. The socket as claimed in claim 2, wherein the engaging recess has a plurality of ridges and grooves defined in an inner periphery thereof, the ridges and the grooves being alternatively arranged from each other in the inner periphery of the recess, each ridge having an enlarged portion extending radially outward therefrom, a ratio for a width between the two enlarged portions of two adjacent ridges and a width of a bottom of each groove being 1:1.2.

4. The socket as claimed in claim 2, wherein the recess is a hexagonal recess.

5. A socket comprising:
a tubular body having a connection recess defined in a first end of the tubular body and an engaging recess defined in a second end of the tubular body, the engaging recess having a plurality of ridges and grooves defined in an inner periphery thereof, the ridges and the grooves being alternatively arranged from each other in the inner periphery of the engaging recess, each ridge having an enlarged portion extending radially outward therefrom, a ratio for a width between the two enlarged portions of two adjacent ridges and a width of a bottom of each groove being 1:1.2.
